(19) United States
(12) Patent Application Publication
(10) Pub. No.: US 2005/0235718 A1
(43) Pub. Date: Oct. 27, 2005

(54) Organic amino acid chelates, methods for making such chelates, and methods for using such chelates

(76) Inventors: Kevin Dickinson, Layton, UT (US); Jeremy O'Brien, Kaysville, UT (US); Stephen D. Ashmead, Clinton, UT (US); Jennifer Hartle, Harrisville, UT (US)

Correspondence Address: KENNETH HORTON;KIRTON & MCCONKIE, P.O. BOX 45120, SALT LAKE CITY, UT, 84145-0120, US

(21) Appl. No.: 10/969,584

(22) Filed: Oct. 20, 2004

Related U.S. Application Data
(60) Provisional application No. 60/563,940, filed on Apr. 21, 2004.

(51) Int. Cl. C05F 1/00

(52) U.S. Cl. 71/11

(57) ABSTRACT

Organic approved amino acid chelate foliar fertilizer compositions, methods for making such compositions, and methods for using such compositions are described. The foliar fertilizer compositions contain only negligible amounts of wetting agents, anti-foaming agents, preservatives, anti-microbial agents, and similar additives. The foliar fertilizers are also made from starting materials that are organic-approved. Therefore, the fertilizer compositions qualify as an organic material under the respective federal or state regulations. As well, the foliar fertilizers are dried after the chelation process, rather than being kept in solution. Therefore, the foliar fertilizers can be stored and shipped inexpensively.

### CROSS-REFERENCE TO RELATED APPLICATION

This application claims priority of U.S. Patent Application No. 60/563,940, filed on Apr. 21, 2004, the disclosure of which is incorporated herein by reference.

### FIELD OF THE INVENTION

The invention generally relates to the field of mineral amino acid chelates and methods for making and using such chelates. In particular, the invention relates to mineral amino acid chelates that are used as fertilizers. More particularly, the invention relates to mineral amino acid chelates fertilizers that are derived from specific ingredients and that comply with specific product certification guidelines.

### BACKGROUND OF THE INVENTION

There are numerous types of fertilizers that are known and used in the art. One type of fertilizer is applied to the leaves of plants and often is referred to as a foliar fertilizer. One type of foliar fertilizer contains amino acid chelate compounds. When properly formed, amino acid chelates are stable products having one or more five-membered rings formed by reaction between the carboxyl oxygen, and the alpha-amino group of an alpha-amino acid with the metal ion. Such a five-membered ring is defined by the metal atom, the carboxyl oxygen, the carbonyl carbon, the alpha-carbon and the alpha-amino nitrogen. The actual structure will depend upon the ligand to metal mole ratio. See also U.S. Pat. Nos. 3,969,540, 4,020,158, 4,076,803, 4,103,003, 4,167,564, 4,169,716, 4,169,717, 4,172,072, 4,201,793, 4,216,143, 4,216,144, 4,491,464, 4,599,152, 4,725,427, 4,774,089, 4,830,716, 4,863,898, 5,162,369, 5,292,538, 5,292,729, 5,516,925, 5,596,016, 5,614,553, 5,882,685, 5,888,553, 6,114,379, 6,159,530, 6,166,071, 6,207,204, 6,294,207, 6,299,914, 6,407,138, 6,426,424, 6,458,981, 6,518,240, 6,706,904, 6,710,079, and 6,716,814, the disclosures of which are incorporated herein by reference.

Foliar fertilizers are typically prepared by using weak acids as a processing aid. The fertilizers also usually contain wetting agents and anti-foaming agents to defeat the plant's normal water repellant properties, thereby facilitating absorption of the nutrients in the foliar fertilizer by the plant. Foliar fertilizers also contain other processing aids and additives (such as suspending agents, compatability agents and emulsifying agents) that are used to enhance their properties.

Foliar fertilizers are usually maintained in solution from the time of their manufacture until they are applied to the leaves or other parts of a plant. Maintaining them in solution requires the use of preservatives to prevent the growth of bacteria and molds in the solution. These bacteria usually grow because of the specific ligands that are used in the chelating process. Additional problems also occur while the foliar fertilizer is in solution, e.g., increased costs due to shipping and increased likelihood of the chelates precipitating out of solution during storage and shipping.

Foliar fertilizers are subject to federal and state regulatory requirements because they can impact the quality of food and the environment. These requirements regulate the registration, use, and sale of the foliar fertilizers. Recently, the U.S. Department of Agriculture adopted strict guidelines for the types of ingredients and the methods of processing that can be used for foliar fertilizers. See 7 CFR Part 205 National Organic Program Final Rule, the disclosure of which is incorporated herein by reference.

These federal regulations established national standards for the production and handling of organically produced products, including a list of substances approved for—and prohibited from—use in organic production and handling. In other words, these regulations (including future amendments to these regulations and future regulations that may be enacted) require that for a material (including foliar fertilizers) to be classified as “organic,” the starting material(s) for the foliar fertilizer must be naturally-occurring or fall within a specific category of synthetic material (collectively “organic-approved”). Similar regulations have also been adopted by the state of Washington. See Chapter 16-157 WAC, the disclosure of which is incorporated herein by reference. These regulations also prohibit “organic” foliar fertilizers from containing wetting agents, anti-foaming agents, and preservatives.

### SUMMARY OF THE INVENTION

The invention relates to organic amino acid chelate foliar fertilizer compositions, methods for making such compositions, and methods for using such compositions. The foliar fertilizer compositions contain only negligible amounts of wetting agents, anti-foaming agents, preservatives, anti-microbial agents, and similar additives. The foliar fertilizers are also made from starting materials that are organic-approved. Therefore, the fertilizer compositions qualify as an organic material under the respective federal or state regulations. As well, the foliar fertilizers are dried after the chelation process, rather than being kept in solution. Therefore, the foliar fertilizers can be stored and shipped inexpensively.

### BRIEF DESCRIPTION OF THE FIGURES

The following description of the invention can be understood in light of the Figures, in which:

FIG. 1 illustrate a process of making the amino acid chelate compounds in one aspect of the invention; and

FIGS. 2-4 depict the results of methods of using the foliar fertilizers in several aspects of the invention.

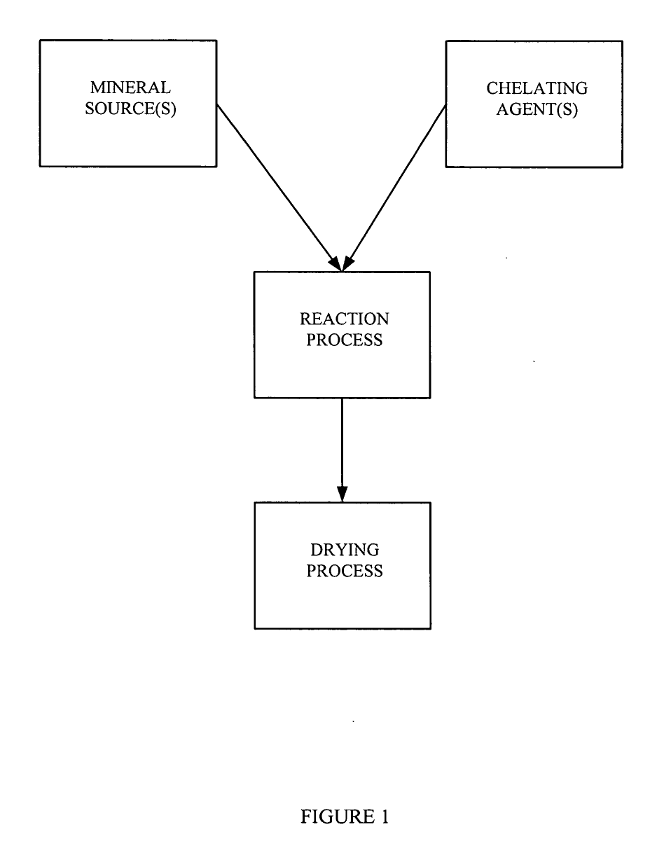

FIGS. 1-4 presented in conjunction with this description are views of only particular—rather than complete—portions of the compositions and methods of making and using the compositions according to the invention. Together with the following description, the Figures demonstrate and explain the principles of the invention. In the Figures, the thickness of layers and regions are exaggerated for clarity. The same reference numerals in different drawings represent the same element, and thus their descriptions will be omitted.

### DETAILED DESCRIPTION OF THE INVENTION

The following description provides specific details in order to provide a thorough understanding of the invention. The skilled artisan, however, would understand that the invention can be practiced without employing these specific details. Indeed, the invention can be practiced by modifying the illustrated method and resulting product and can be used in conjunction with apparatus and techniques conventionally used in the industry. The invention described below deals primarily with amino acid chelate foliar fertilizers for application to plants. The invention, however, could be modified for other uses, such as nutritional supplements for animals or humans. In addition, other chelating ligands could also be used instead of amino acids, such as organic acids containing ascorbic acid, citric acid, tartaric acid, acetic acid, fulvic acid, humic acid and the like, as well as lignin solfonate.

As described above, the invention includes amino acid chelate foliar fertilizers that can be classified as organic. To be so classified, the foliar fertilizers of the invention contain negligible or no amounts of wetting agents, anti-foaming agents, anti-microbial agents, preservatives, and similar additives. As well, the foliar fertilizers are made from starting materials that can be classified as organic-approved. Any foliar fertilizer exhibiting these properties is included within the scope of the invention, including those described below.

The structure and chemistry of amino acid chelates are well known. See, for example, Ashmead et al., Chelated Mineral Nutrition, (1982), Chas. C. Thomas Publishers, Springfield, Ill.; Ashmead et al., Intestinal Absorption of Metal Ions, (1985), Chas. C. Thomas Publishers, Springfield, Ill.; Ashmead et al., Foliar Feeding of Plants with Amino Acid Chelates, (1986), Noyes Publications, Park Ridge, N.J.; U.S. Pat. Nos. 4,020,158; 4,167,564; 4,216,143; 4,216,144; 4,599,152; 4,774,089; 4,830,716; 4,863,898; and 4,725,427; the entire disclosures of which are incorporated by reference. As a brief exemplary explanation, amino acid chelates and complexes are compounds that contain metal ions bonded to amino acid ligands. In the case of amino acid chelates, the compounds form one or more heterocyclic rings. For example, the chemical structure of ferrous amino acid chelate (or ferrous biglycinate chelate) is 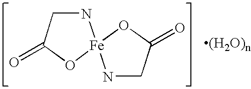
where an atom of iron is bonded to two molecules of glycine. The chemical bond at the carboxyl oxygen group may be coordinate covalent, covalent, and/or ionic. At the alpha-amino group, the chemical bond is typically a covalent or coordinate covalent bond.

Any organic amino acid can be used as the ligand for the chelates in the invention. Examples of such ligands include naturally-occurring single amino acids like alanine, arginine, asparagine, aspartic acid, cysteine, cystine, glutamine, glutamic acid, glycine, histidine, hydroxyproline, isoleucine, leucine, lysine, methionine, ornithine, phenylalanine, proline, serine, threonine, tryptophan, tyrosine, valine, and combinations thereof. Ligands other than single amino acids (e.g. dipeptides, tripeptides, tetrapeptides, and other polypeptides formed by any combination of the single amino acids) may also be used as the organic amino acid ligand.

The amino acids are typically chelated to minerals to obtain the stable form of the compound. The minerals that can be used in the compounds include any transition metal, any alkaline earth metal, boron, Se, K, as well as calcium, copper, iron, magnesium, manganese, and zinc.

The foliar fertilizers of the invention can contain any amount of additives (e.g., wetting agents, anti-foaming agents, anti-microbial agents, preservatives, and similar additives) that will allow the foliar fertilizer to be classified as organic under the respective regulation (whether present or future). In one aspect of the invention, the foliar fertilizers contain only negligible amounts (i.e., up to about 0.1 wt %) of such additives.

Thus, the foliar fertilizers can contain up to about 0.1 wt % wetting agents, up to about 0.1 wt % anti-foaming agents, up to about 0.1 wt % anti-microbial agents, up to about 0.1 wt % preservatives, and up to about 0.1 wt % of similar additives. In another aspect of the invention, the foliar fertilizers of the invention contain only trace amounts of such additives. In yet another aspect of the invention, the foliar fertilizers of the invention contain only about 0 wt % of such additives.

The foliar fertilizers contain limited (or no amounts) of such additives that are conventionally used because their inclusion is prohibited by the certification regulations. To the extent such additives or other materials (whether they are now known and not used or whether they are discovered) can become organic-approved, they can be used in the foliar fertilizers of the invention. As well, the foliar fertilizers could be modified to be organic-approved under governmental regulations other than those described herein.

The foliar fertilizers of the invention can be made or produced in either a liquid or a solid form. In one aspect of the invention, the foliar fertilizers are in a solid form. The foliar fertilizer can be made in any solid form known in the art, including powders, tablets, capsules, or granules.

The foliar fertilizers of the invention are made by any process that manufactures the compositions with the properties described above. In one aspect of the invention, and as illustrated in FIG. 1, the foliar fertilizers are made by mixing or reacting an organic-approved mineral source with a chelating agent in an aqueous solution. In one aspect of the invention, the pH of the solution can range from about 6 to about 9. The aqueous solution serves to effect the chelation or complexation reaction and may include de-ionized, non-deionized, de-aerated, or non-deareated, filtered or unfiltered water.

Any chelating agent known in the art can be used in this reaction. Examples of such chelating agents include any known hydrolyzed vegetable protein, yeast, naturally occurring organic acids, algae extracts, and other organic-approved sources. Examples of hydrolyzed vegetable proteins include soy, rice, and wheat. Of course, any other chelating agent listed in the respective regulation(s) can also be used in the invention.

The mineral source that is used in the reaction includes any material that is approved as organic by the regulatory guidelines discussed above. Examples of such materials include elemental metals, metal sulfates, metal oxides, metal carbonates, metal chlorides, metal borates, and combinations thereof. Examples of metal sulfates that can be used include sulfates of iron, zinc, magnesium, copper, manganese, molybdenum, selenium and cobalt. Examples of metal oxides that can be used in the invention include oxide of iron, zinc, copper, manganese, molybdenum, selenium and cobalt. With the metal oxides, however, an acid may need to be used as a processing aid. Examples of metal carbonates that can be used include calcium and magnesium carbonate. Examples of metal chlorides that can be used in the invention include calcium and magnesium chloride. In one aspect of the invention, calcium chloride is used as the mineral source. Examples of metal borates that can be used include sodium tetraborate, sodium borate, calcium borate, and various hydrated forms or derivatives of these borates.

The process for making the mineral amino acid chelate compounds is carried out for a time and under operating conditions sufficient to substantially complete the reaction. In one aspect of the invention, the reaction is carried out until the desired chelate compound is completed. In another aspect of the invention, however, the reaction is carried out only until the desired complex is completed. The reaction process can be aided by any known mixing (i.e., stirring) process.

The time for the reaction process will depend on the desired degree of completion of the reaction. Generally, the time for the reaction can range from about 0 to about 60 minutes. In one aspect of the invention, the time for the reaction can range from about 1 to about 24 hours.

The temperature for the reaction process will also depend on the desired degree of completion of the reaction. The temperature for the reaction can range from about 25 to about 80 degrees.

When the reaction is complete, the foliar fertilizer is in a liquid form, i.e., in solution. In one aspect of the invention, the foliar fertilizer solution is then dried into a powder using any suitable drying process. Any drying process known in the art can be used, including oven drying, drum drying, fluidized granulation, other commercially viable drying methods, or combinations thereof. In one aspect of the invention, the drying processes used in the invention comprises spray-drying.

If desired, the powder can be converted into another solid form like a tablet, capsule, granule or the like by any known process in the art. Conversion into these solid forms is especially useful where the amino acid chelate will be used other than as a fertilizer.

There are several advantages to having the foliar fertilizer compositions of the invention in a solid form. First, they are light for shipping and therefore economical. Second, there exists little to no precipitation of the chelate compound out of solution during shipping or long periods of storage. Third, since they are dry, there is little or no need for preservatives or anti-microbial agents.

The amino acid chelate compounds of the invention have many possible uses. First, they may be used as plant foliar fertilizers and nutrients as described above. For such uses, the composition can be dissolved for use on leaves or other parts of the plant, or it can be used directly as a soil treatment. Second, the compounds can also be dry blended in combination with other metal salts and/or a variety of ligands for more unique applications. Third, these chelates and complexes can also be used in animal feeds by any method currently known in the art. And fourth, some of the compounds can be used in food applications, in pharmaceuticals, and/or nutritional supplements for crustaceans, reptiles and warm-blooded animals, including humans.

The foliar fertilizers of the invention and the methods of making and using such foliar fertilizers are exemplified in the following examples.

### EXAMPLE 1

282 lbs of calcium chloride didrate was obtained. 287 lbs of non-synthetic amino acids were obtained from soybeans in the following manner. The soybeans are first ground into a powder. The powder was then suspended in water and subjected to hydrolysis. The resulting liquid was then mechanically filtered in a filter press to remove the solid materials. The liquid was then dried in a spray dried until a powder was obtained.

These two components (calcium chloride didrate and non-synthetic amino acids) were mixed in an aqueous solution and reacted until the chelation was complete and then spray dried until a powder was obtained. The chelated composition contained 56 wt % of the calcium chloride hexahydrate and 44 wt % of the non-synthetic amino acids. The chelated composition contained just these two components.

### EXAMPLE 2

A zinc amino acid chelate composition was prepared similar to the process described in Example 1, except that zinc 804 was used in place of calcium chloride hexahydrate. The resulting product contained 20 wt % zinc.

80 grams of actual zinc in the zinc amino acid chelate applied per acre was selected as the standard (or 1×) rate. The amount of the dry product necessary to apply this standard rate was then calculated. Applications were then made to canning beans at the following rate: 0.2×, 0.4×, 0.6×, 1×, 1×, 2×, 3×, 4×, 6×, and 8×. Plant tissue samples were then taken 7 days following the application.

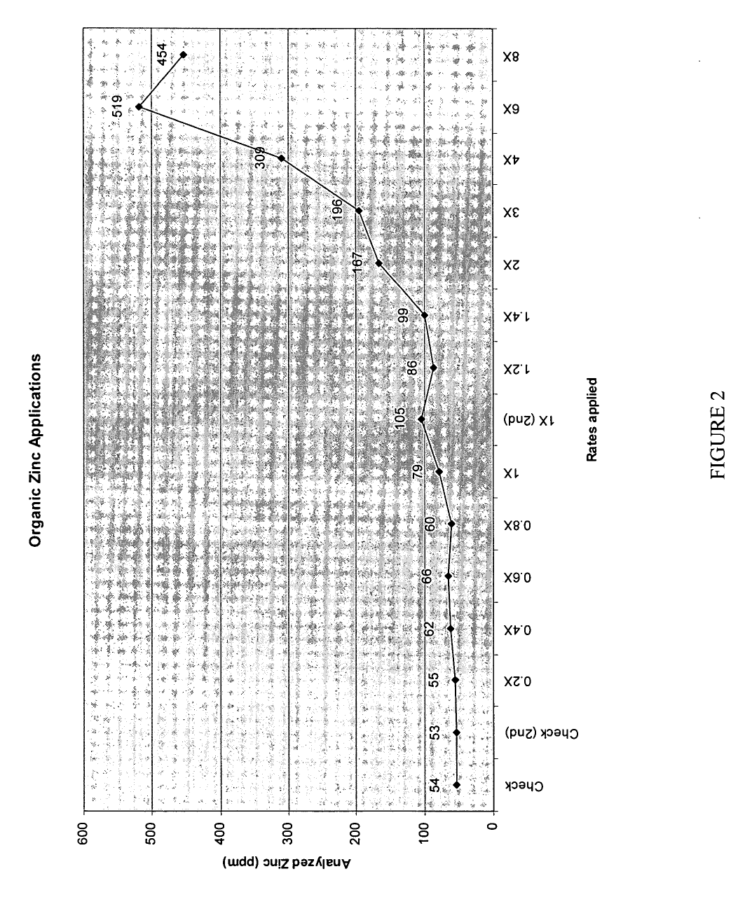

There was no burn observed on any plants at any of the rates applied. A summary of the plant tissue analysis is depicted in FIG. 2. As shown in FIG. 2, there was a nice dose versus response trend.

### EXAMPLE 3

A calcium amino acid chelate composition was prepared similar to the process described in Example 1, except that calcium was used in place of calcium chloride hexahydrate. The resulting product contained 17.8 wt % calcium.

60 grams of actual calcium in the calcium amino acid chelate applied per acre was selected as the standard (or 1×) rate. The amount of the dry product necessary to apply this standard rate was then calculated. Applications were then made to canning beans at the following rates: 1×, 2×, 3×, 4×, 5×, 6×, 7×, and 8×. Plant tissue samples were then taken 5 days following the application.

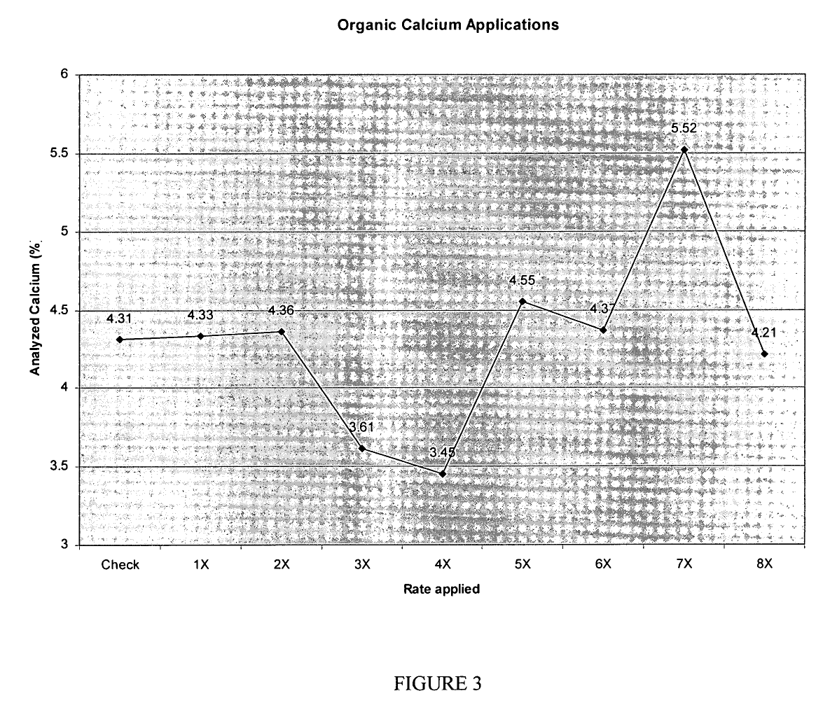

There was no burn observed on any plants at any of the rates applied. A summary of the plant tissue analysis is depicted in FIG. 3.

### EXAMPLE 4

A calcium amino acid chelate composition was prepared similar to the process described in Example 1, except that calcium acetate was used in place of calcium. The resulting product contained 0 wt % calcium.

60 grams of actual calcium in the calcium amino acid chelate applied per acre was selected as the standard or 1× rate. The amount of the dry product necessary to apply this standard rate was then calculated. Applications to made to canning beans at the following rates: 1×, 2×, 4×, and 8×. Plant tissue samples were then taken 5 days following the application.

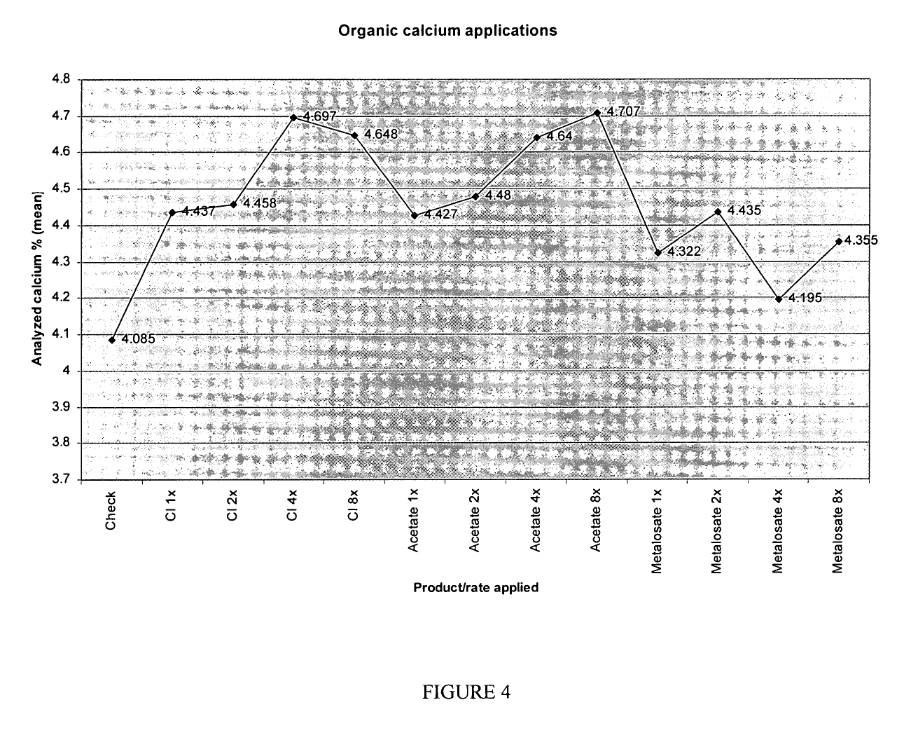

A summary of the plant tissue analysis is depicted in FIG. 4. FIG. 4 also compared the results of Example 3 with this example (Example 4). Both of these results were compared with a non-organic approved calcium amino acid chelate sold as Metalosalate® calcium.

### EXAMPLE 5

Several batches of foliar fertilizer compositions were made in the following manner using the information in Table 1. The reported amount of hot tap water was provided in a container. The reported amount of a mineral source was then added to the water and the mixture was stirred. The reported amount of CVP LS-hydrolyzed soy protein (9.46 wt % N, 0.857 wt % Mg, and 2.39 wt % Ca) as a chelating agent was then added and the mixture was stirred until the chelating agent was completely dissolved and there were no lumps present. The mixture was then spray dried until a powder was obtained and the amount of mineral in the powder was measured.

TABLE 1

| | | | Mineral | Chelating | |
|---|---|---|---|---|---|
| Foliar | Water | | Source | Agent | Wt % |
| Fertilizer | (lbs) | Mineral Source | (lbs) | (lbs) | Mineral |
| Manganese | 171.72 | Manganese | 529.81 | 470.19 | 16.4 |
| Organic | | Sulfate (31 wt % | | | |
| Powder | | Mn) | | | |
| Magnesium | 159.09 | Magnesium | 796.98 | 484.97 | 6.5 |
| Organic | | sulfate (9.8 wt % | | | |
| Powder | | Mg) | | | |
| Iron Organic | 159.65 | Ferrous Sulfate | 807.90 | 435.84 | 15 |
| Powder | | (20 wt % Fe) | | | |
| Copper | 171.70 | Copper Sulfate | 760.87 | 457.06 | 16 |
| Organic | | (25 wt % Cu) | | | |
| Powder | | | | | |
| Calcium | 159.92 | Calcium Chloride | 494.98 | 505.02 | 12.9 |
| Organic | | (26 wt % Ca) | | | |
| Powder | | | | | |
| Zinc Organic | 175.05 | Zinc Sulfate | 544.72 | 455.28 | 19.3 |
| Powder | | (35.5 wt % Zn) | | | |

Having described the preferred aspects of the invention, it is understood that the invention defined by the appended claims is not to be limited by particular details set forth in the above description, as many apparent variations thereof are possible without departing from the spirit or scope thereof.

1. An amino acid chelate composition containing less than a negligible amount of at least one of wetting agents, anti-foaming agents, anti-microbial agents, preservatives, and similar additives.

2. The composition of claim 1, wherein the negligible amount is 0.1 wt %.

3. The composition of claim 1, wherein the composition contains only trace amounts of wetting agents, anti-foaming agents, anti-microbial agents, preservatives, and similar additives.

4. The composition of claim 1, wherein the composition contains only a negligible amount of a wetting agent.

5. The composition of claim 1, wherein the composition contains only a negligible amount of an anti-foaming agent.

6. The composition of claim 1, wherein the composition contains only a negligible amount of an anti-microbial agents.

7. The composition of claim 1, wherein the composition contains only a negligible amount of a preservative.

8. The composition of claim 1, wherein the composition contains no wetting agents, anti-foaming agents, anti-microbial agents, preservatives, and similar additives.

9. The composition of claim 1, wherein the composition is in a solid form.

10. A foliar fertilizer comprising an amino acid chelate composition and negligible amounts of at least one of wetting agents, anti-foaming agents, anti-microbial agents, preservatives, and similar additives.

11. The fertilizer of claim 10, wherein the negligible amount is 0.1 wt %.

12. The fertilizer of claim 10, wherein the composition contains only trace amounts of wetting agents, anti-foaming agents, anti-microbial agents, preservatives, and similar additives.

13. The fertilizer of claim 10, wherein the composition contains no wetting agents, anti-foaming agents, anti-microbial agents, preservatives, and similar additives.

14. A nutrient system comprising a foliar fertilizer containing an amino acid chelate composition and negligible amounts of at least one of wetting agents, anti-foaming agents, anti-microbial agents, preservatives, and similar additives.

15. An organic approved amino acid chelate composition.

16. A foliar fertilizer consisting essentially of an amino acid chelate composition.

17. A method for making an amino acid chelate composition, comprising:
providing a organic-approved mineral source;
providing a chelating agent; and
mixing these components together in an aqueous solution.

18. The method of claim 17, wherein the organic-approved mineral source comprises elemental metals, metal sulfates, metal oxides, metal carbonates, metal chlorides, metal borates, and combinations thereof.

19. The method of claim 17, wherein the chelating agent comprises hydrolyzed vegetable protein.

20. The method of claim 17, further including drying the mixture.

21. A method for making an amino acid chelate composition, comprising mixing a organic-approved mineral source and a chelating agent in an aqueous solution while using negligible amounts of at least one of wetting agents, anti-foaming agents, anti-microbial agents, preservatives, and similar additives.

22. The method of claim 21, wherein the negligible amount is 0.1 wt %.

23. The method of claim 21, comprising only trace amounts of wetting agents, anti-foaming agents, anti-microbial agents, preservatives, and similar additives.

24. The method of claim 21, comprising using no wetting agents, anti-foaming agents, anti-microbial agents, preservatives, and similar additives.

25. A method of fertilization, comprising:
providing an amino acid chelate composition containing less than a negligible amount of at least one of wetting agents, anti-foaming agents, anti-microbial agents, preservatives, and similar additives; and
applying the composition to the leaves of plants or to the soil.

26. A method of providing nutrition, comprising:
providing an amino acid chelate composition containing less than a negligible amount of at least one of wetting agents, anti-foaming agents, anti-microbial agents, preservatives, and similar additives; and
administering the composition to an animal or human.
